(19) United States
(12) Patent Application Publication
(10) Pub. No.: US 2012/0011570 A1
(43) Pub. Date: Jan. 12, 2012

(54) WEB-BASED AID FOR INDIVIDUALS WITH COGNITIVE IMPAIRMENT

(76) Inventor: Merilee Griffin, East Lansing, MI (US)

(21) Appl. No.: 13/172,973

(22) Filed: Jun. 30, 2011

Related U.S. Application Data
(60) Provisional application No. 61/363,444, filed on Jul. 12, 2010.

(51) Int. Cl. H04L 9/32; G06F 15/16

(52) U.S. Cl. 726/4; 709/203

(57) ABSTRACT

A system for assisting an individual with cognitive impairment including a display device adapted to connect to a remote server and a dedicated website hosted on the remote server and remotely accessible by an authorized individual dedicated to hosting content for the individual with cognitive impairment. A homepage is displayed on the display device. The homepage displays content provided by the dedicated website. A plurality of informational icons are provided on the homepage. The information icons are adapted to display content from the dedicated website. The authorized individual can modify and transmit content to the homepage through the website to be accessed by the individual with cognitive impairment through the display device.

### CROSS-REFERENCE TO RELATED APPLICATION

This application claims the benefit of U.S. Provisional Patent Application No. 61/363,444, filed Jul. 12, 2010, the disclosure of which is incorporated herein by reference in its entirety.

### BACKGROUND

The present disclosure relates generally to a web-based system and method for aiding individuals in their daily routine and life management, particularly those suffering with cognitive impairment and mild to severe memory loss.

### DESCRIPTION OF THE RELATED ART

Many people suffering from memory loss and cognitive impairment such as elderly people in the early stages of Alzheimer's disease and other dementia-related illnesses live independently in their own homes or in assisted-living facilities. Although they may be capable of basic self-care and housekeeping, often they require or benefit from supervision and additional assistance remembering to take medications, getting to appointments, performing regular routine tasks, etc. In some cases, the individuals need several reminders throughout the day to achieve one task. Loss of short-term memory further causes significant confusion and frustration, thus significantly impacting an individual's quality of life. Moreover, those close to the affected individual are further impacted as a result of increased worry and caregiving-related responsibility. For example, a mother suffering from dementia may need frequent telephone calls or visits from her children in order to remember to take a medication on time, and further to remind her that she has already taken the medication. Overdosage of a medication can be a major risk of injury or death causing anxiety for both the suffering individual and his or her family.

Short-term memory loss and limitations can often cause the person to dwell on a particular problem. For example, the person might worry about whether he/she paid certain bills, needs to see the doctor, sent a birthday gift, and the like. Such individuals often ask questions and get answers, but then forget the answers. They may repeat the same question or concern many times a day. Frequently, just remembering the day of the week is troublesome.

Persons with cognitive impairment such as dementia are often dependent on their adult children to assist with these memory problems. The children may be working full time, raising families of their own, and/or living in distant cities. Worrying about whether a loved one remembers to take his or her heart medication can be stressful and the frequent interruptions and obligations during the day can be disruptive. Accordingly, there is a need in the art for a user-friendly device and system for patients suffering from cognitive impairment and memory loss for managing routine activities and interacting with family members and other caregivers.

### SUMMARY

The present disclosure relates to a system for assisting an individual with cognitive impairment including: (a) a display device adapted to connect to a remote server; (b) a dedicated website hosted on the remote server and remotely accessible by an authorized individual dedicated to hosting content for the individual with cognitive impairment; (c) a homepage displayed on the display device, wherein the homepage displays content provided by the dedicated website; and (d) a plurality of information icons provided on the homepage, the information icons adapted to display content from the dedicated website. The authorized individual can modify and transmit content to the homepage through the website to be accessed by the individual with cognitive impairment through the display device. The homepage can be customizable according to preferences of the individual with cognitive impairment. Each information icon can include an illustrative or text indicia associated with specific content to be viewed on the display device.

In an example, the display device includes a touch screen display adapted to allow navigation of the homepage through physical contact with portions of the touch screen display. The information icons can include at least one navigation link to a specific content display page associated with the information icon. The dedicated website can be password protected and accessible by the authorized individual. The website can be accessed by a plurality of authorized individual each given a unique password and a predetermined authorized security level for content modification.

In a further example, the information icons display: (a) current day of the week, date, and time data; (b) a schedule of events; (c) a to-do list; and (d) a scrolling dedicated message provided by an authorized individual. The display device can include auditory notification adapted to deliver audible messages or alarms associated with the information icons. The display device can be configured to prevent homepage modification capability by the individual with cognitive impairment. The display device can further include an audio recording feature to allow voice recordings to the homepage and uploaded back to the website for access by the authorized individual. At least one of the information icons can be a task list which includes and actionable completion button to be activated by the individual with cognitive impairment. Activating the completion button communicates to the website that the task is completed.

The present disclosure further provides for a method of assisting an individual suffering from cognitive impairment including the steps of: (a) connecting a display device to a remote server hosting a dedicated website having content dedicated for the individual with cognitive impairment; (b) displaying a homepage on the display device, wherein the homepage displays content provided by the dedicated website; (c) accessing the dedicated website remotely to modify, transmit, or upload content to the dedicated website, wherein access to the dedicated website and modification ability is limited to one or more authorized individuals; and (d) transferring the content from the dedicated website to the homepage for viewing by the individual with cognitive impairment on the display device. The modification of the website can include the steps of: (a) accessing the dedicated website by an authorized individual; (b) selecting one or more content options to be viewed on the homepage; (c) optionally providing a personalized message; and (d) transmitting the modifications to be viewed on the homepage.

The present disclosure still further provides for a system for management of care for a plurality of individuals with cognitive impairment including: (a) a plurality of display devices adapted to connect to a remote server, each device associated with a unique homepage configured for each unique individual with cognitive impairment; (b) a plurality of dedicated websites hosted on the remote server and remotely accessible by an authorized caregiver, wherein each dedicated website is adapted to provide unique content to a corresponding homepage hosted on the display devices for the associated individual with cognitive impairment; and (c) a dedicated master website hosted on the server configured to allow access by the authorized caregiver to view, modify, and provide content to each dedicated website to be viewed in the unique homepage for each individual with cognitive impairment. Each website is accessible by one or more authorized users remotely through the server. The master website is accessible remotely by the authorized caregiver. The caregiver can view content-based displays associated with each individual with cognitive impairment by sorting information about the individuals by one or more desired attributes.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 illustrates a dedicated device having a display for displaying an interactive and customizable homepage according to a system of the present disclosure.

FIG. 2 illustrates a display and homepage associated with the dedicated device of FIG. 1 according to the present disclosure.

FIG. 3 illustrates a calendar display associated with the homepage display of FIG. 2.

FIG. 4 illustrates a customization and modification display for determining content for the homepage of the display of FIG. 2.

FIG. 5 illustrates a communication flow chart according to the present disclosure.

FIG. 6 illustrates a flow chart for a system of multi-patient care management associated with the present disclosure.

### DESCRIPTION

The present disclosure provides for a system, apparatus, and method that assists individuals with short-term memory loss or cognitive impairment. Progressive diseases such as Alzheimers and Parkinsons, brain injuries, vascular dementia (e.g., stroke), drug interactions, chemical imbalances, and other causes of mild to moderate dementia can cause mild to severe memory loss and cognitive impairment. The present disclosure provides for a system including a device having a display and a programmable application adapted to be modified remotely by one or more authorized individuals such as family members or caregivers using a web-based application.

The display is configured to alleviate frustrations and stresses associated with each individuals degree of impairment and memory loss functionality. The system allows remote accessibility by the patient's caregiver or family member to drive the content of the display and assist in alleviating confusion by the patient typical of such impairments. Items or tasks on a schedule can be customized to trigger an audible alarm as a reminder. Messages and tasks can be displayed in large characters on the display for ease of viewing. The device can facilitate direct communication between the caregiver or family and the patient to alleviate confusion and anxiety associated with these impairments. Moreover, the device provides for redundancies in communicating important information to further alleviate anxiety and stress common of those suffering from frequent memory loss. An example notification can be to instruct the patient to get ready for an appointment or take a pill. Family members can add one-time or repeating events and individualized or customized ringtone alarms.

The present disclosure provides a system for users who have minimal or no computer skills or experience. The system can be configured to display information automatically so all the user has to do is read the display. Some users may learn simple navigation of the system and thus able to view optional features. However, navigation functionality can be limited. The navigation can be configured to a loop from home page to other feature, and back again. The user should not be confused by having several features, windows, or applications running. A protocol can be established for introducing the device to someone who is elderly, confused, and possibly resistant to technology or change. The device can be configured to return automatically to a home screen after a set period of inactivity, so that it does not stay indefinitely on optional displays of the device such as weather or a photo album. If the device becomes lost, the caregiver can cause it to sound an alert to help the owner locate it. When editing the content the caregiver can see exactly what is visible on the device by clicking on a view tab.

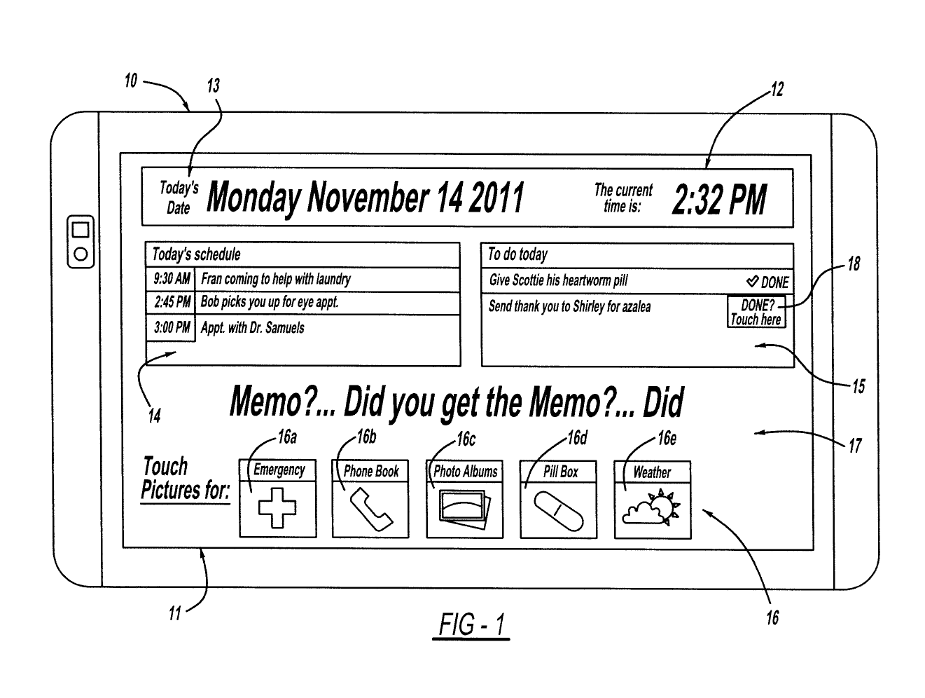

Referring to FIGS. 1-4, in an example, a dedicated device 10 having a display 11 is provided. Device 10 can be a tablet and can be fixed at a location or portable. In this example, device 10 defines a substantially rectangular geometry with an elongated horizontal dimension and a shorter vertical dimension. Device 10 can include an LCD screen coupled to non-visible computer processing. The LCD screen can be constructed to provide touch screen capability to allow the user to navigate to other programs or display pages associated with device 10 through the touch of a finger. Device 10 can be constructed to be relatively light and portable for use on a tabletop or the like. The computer processing of device 10 is operable to connect to the internet. Connection to the internet can be through any known connection means such as a hard connection through a cable, or through a wireless antenna to a wireless network or the like. Device 10 can connect to the internet via an adaptor with a USB port, a 3G or 4G connection or a wireless router.

In an example, device 10 can be placed or fixed near a patient's favorite chair or other desirable location where it can be viewed frequently and reliably. Placing the device 10 in a clearly visible and reliable location helps alleviate issues of memory loss. The patient can be made accustom to the device location and thereby rely on the information displayed on it when becoming confused or forgetful about critical content such as the day of the week, time of day, or when to take a certain medication.

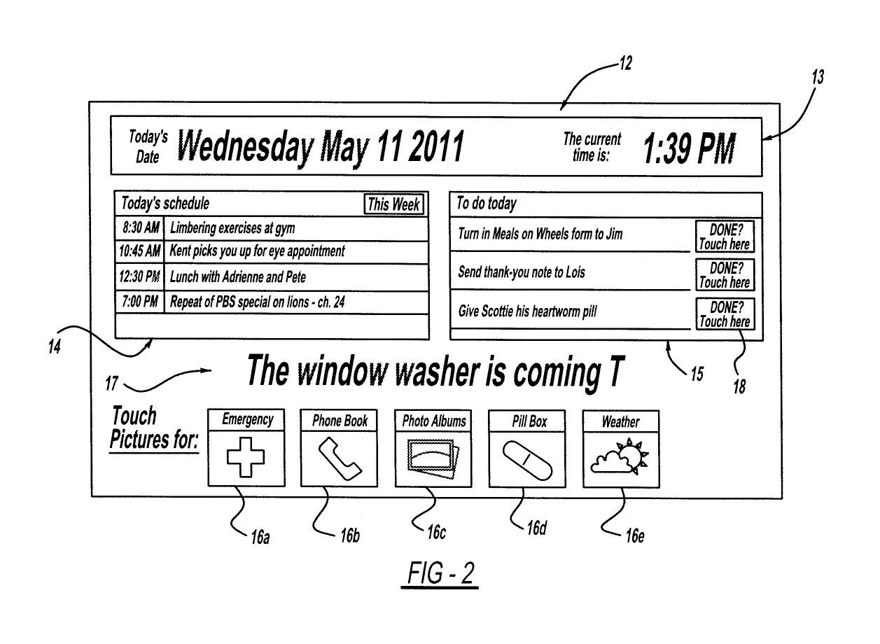

Display 11 is operable to display web-based internet content, particularly content that is dedicated to assist those with cognitive impairment, particularly those who suffer from memory loss. FIG. 2 illustrates an example homepage 12 on display 11 that is associated with a program or system dedicated to providing desired information to a user with cognitive impairment. A remote server can host the website associated with the homepage 12. The look and content of homepage 12 can be customized according to a user's preferences. Homepage 12 can be customized to meet the needs of a particular user or patient. For example, a person with very mild memory loss may benefit from many features that together provide a lot of content. Someone with worse cognitive impairment might find a lot of content confusing and overwhelming, so a simpler display can be configured for them. The homepage should be configured to alleviate frustrations associated with memory loss and customized to address the individualized difficulties of each individual's unique impairments.

In this example, the homepage 12 displays a plurality of information indicia, which can be referred to as icons, boxes, or gadgets. Each icon can display desired information or provide links to further information to launch a program or navigate to another display page associated with homepage 12 to display additional content. The information icons include date and time icon 13 that displays content such as day of the week, date, time. The date and time icon 13 can be customized to update continuously through the internet connection. In an example, the date and time icon can be configured according to the location of use. Location can be determined by submitting a zip code by an authorized caregiver or through an ip address associated with the homepage. In a further example, the homepage can include a global positioning system (“GPS”) application that determines location of the device. Accordingly, day light savings time, when applicable, and leap year can be automated into the date and time display icon. This allows for updated changes when the device is moved from one location to another or is being used during travel. A weather icon can be updated in a similar manner. Other icons can be provided such as personal schedule icon 14 and a “to-do” list icon 15. The icons can be customized to be displayed in various sizes depending on a patient's preference and need. For example, the date and time can be displayed most prominently in a large distinct font and color if the patient often forgets those particular necessary details of their life.

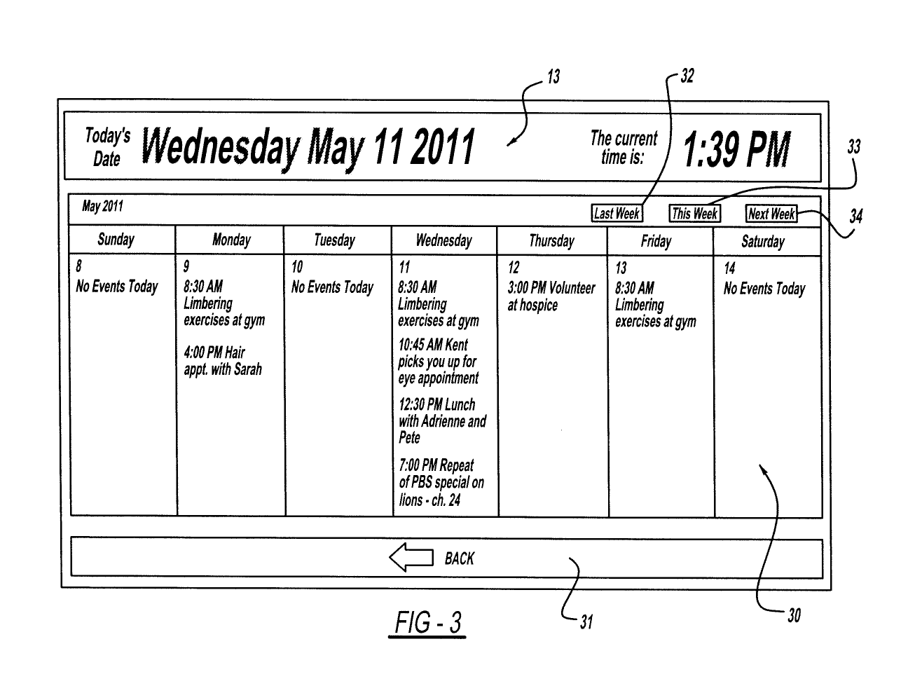

Some information icons can be provided to navigate to other areas of the homepage or information stored on device 10. FIG. 3 illustrates a calendar display 30 which represents another display page accessible through the homepage that displays stored information. Calendar display 30 can be made accessible by physically touching the “today's schedule” icon 14 of FIG. 2. In the calendar display 30 of FIG. 3, the calendar is essentially expanded to show a full weeks view of scheduled events. Additional icons such as last week tab 32, this week tab 33, and next week tab 34 allow for further navigation to other areas of the calendar. A distinct navigation bar 31 is provided in this example that reads “BACK” with an arrow to allow for the user to navigate back to the previous page. In this example, the day of the week, date, and time information icon 13 is always prominently displayed regardless of which part of the display page is displayed. In an example, each event in the calendar is scheduled for a particular time. An audio alert may be set by a caregiver to emit a sound to draw the user's attention to the device 10 to obtain information about a scheduled event or reminder. Events may be set to repeat at regular intervals by day, week, or month. Archives can be maintained for past events, and future events may be viewed by touching next week tab 34. The to-do list 15 can display tasks without a particular time associated with them. After each item on the to-do list, a completion box 18 is provided that reads “DONE? touch here,” to be touched to display the item as completed. Each task can be set to appear the following day if not marked as completed.

Homepage 12 further provides for a plurality of navigation icons 16 that allow for navigating to a unique dedicated information page associated with homepage 12 for viewing additional content. The navigation icons 16 define an indicia for identification that can include pictures and words such as a picture of a red cross for emergency links or a picture of a telephone to navigate to a location that displays phone numbers. In this example, five picture navigation icons 16 are shown, emergency icon 16a, phone book icon 16b, photo album icon 16c, pill box icon 16d, and weather icon 16e. Selection of icons can be customizable according to a user's preferences or needs. As shown in this example, each icon further displays one or more words, such as “weather” or “photo album” to further provide indication of the content of the icon. In this example, device 10 includes a touch screen display allowing a user to launch applications and navigate from one program to another through direct physical contact with the screen. Typically, the user will use his or her finger to move from one part of the system associated with homepage 12 to another page.

In an example, the photo album icon 16c can be used to organize individual photos into groups. Each photo album can include one or more individual photos. Caregivers can add, delete, or modify both albums and single photos. The pill box icon 16d can be viewed by an entire week by the caregiver who accesses this view remotely and is entering correct information about which medications to take and at what times. Entries can be set to repeat daily. The caregiver can further adjust or modify the view or display of homepage 12 viewed by the patient to a single day view since a whole week view may be confusing to some individuals with cognitive impairment. Likewise, in a further example, the caregiver can view an entire month of a calendar and limit the view seen by the patient to a single day or a week view. Audio alerts can be preset into the pillbox for each time of day to remind a patient to take medications.

Many of the icons of homepage 12 can include a recognizable image indicia, e.g., a sun and a cloud combination to resemble weather. These can be particularly helpful for individuals with reading difficulty. The size and shape of each information box can further be customized. For example, if the patient most often has trouble remembering the day of the week, then the time and date icon 13 can be emphasized or increased in size relative to the other boxes. In this example, the day of the week, date, and time indicia 13 is displayed most prominently near an upper portion of display 11. Underneath the date and time icon 13 which can be referred to as a date/time information bar 13, are two boxes or windows positioned side by side listing the day's schedule of events 14 and a to-do list 15 respectively. Each event includes an associated scheduled time. This provides the patient with a convenient tool to for remembering scheduled events, for example taking a particular medication or watching a particular television show. In this example, the navigation icons 16 are positioned adjacent a lower portion of display 11 arranged in a row horizontally.

Display 11 can further include a message display 17 displaying a message or collection of words to be viewed by the user. In this example, the message display 17 is positioned above the navigation icons 16 and below the information icons 14 and 15. The message can be fixed in a dedicated space and made visible and inconspicuous to catch the immediate attention of the user. A distinct color or font size can facilitate the distinctiveness of the message. In a further example, message display 17 can be scrolling or referred to as a “crawl.” In yet a further example, message display can trigger an audio alert notifying the user to check the device 10 to read a new message. The message display 17 can display reminders and important information throughout the day. In an example embodiment, it can be set either to crawl across the screen at various speeds, or to display by fading each message in and out at various speeds. In an example, three speeds are provided, slow, medium and fast or variations of the same.

In a further example, an audio and/or visual alarm can activate at the time associated with each scheduled event to alert the individual of that particular event. The audio alert can emit from a sound system integrated into the device 10. In even a further example, an audio response can be activated through a remote by touching the icon that audibly speaks certain desired content. For example, the user can request an audio response through a remote control, alarm, or touching the date icon that states, “Good afternoon, the time is 2:32 PM, on Monday, Nov. 14, 2011. Your next scheduled activity is: Bob picks you up for an eye appointment.” In another embodiment, graphic components of the display can be designed for the visually impaired. Font sizes, size and arrangement of icons, colors, and contrast meet standard recommendations for use by visually impaired persons. In addition, caregivers can record their voices to accompany or replace the written messages, and a greater range of audio alerts and instructions can be programmed to assist the user. Various sound effects can be downloaded from the internet to customize the sound alerts according to the tastes of the user. For example, one person might prefer church chimes while another user would like a jazz phrase from a trumpet. In addition, different sounds can be set for different purposes, for example, a reminder that it is time to take a pill could be a marimba, and a social event might sound a doorbell.

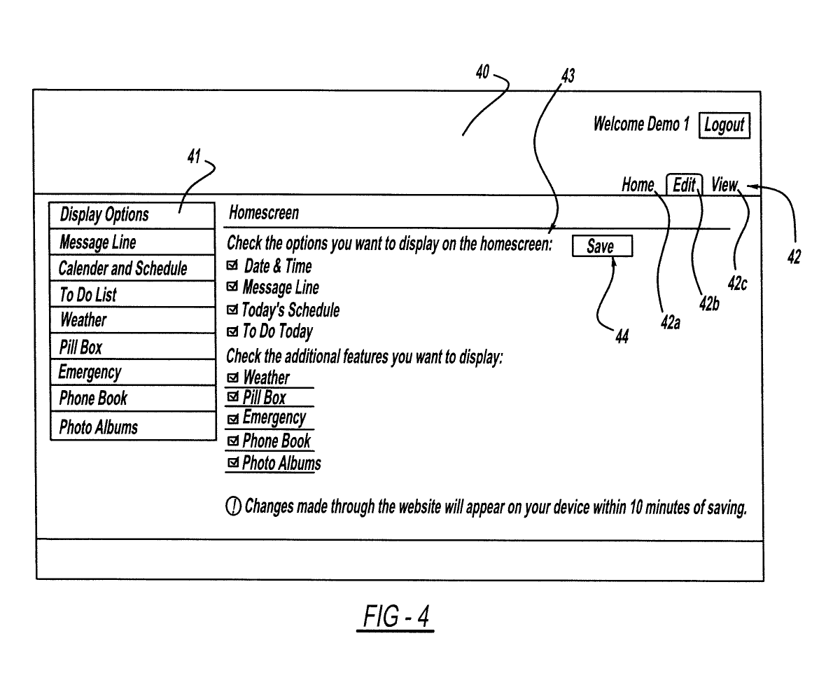

The informational content of the icons of the homepage 12 can be modified and updated through a web-based application as shown through the example modifying website display interface 40 of FIG. 4. Display options 41 are provided to allow for customization of the homepage 12. Each option navigates to a plurality of more specific options to be modified, customized, or selected. Interface 40 further includes one or more navigation tabs 42 to move among several viewing options such as home tab 42a, edit tab 42b, and view tab 42c. A main page 43 allows for certain options to be selected. In this example the options are selected through a display of check marks for each particular content designation such as “date & time” and “message line.” A clearly distinct save icon 44 is provided to allow for frequent saving of modifications. These changes are then communicated and displayed on homepage 12 of the device 10. Moreover, the web-based application can allow for viewing of the homepage to ensure proper changes were made.

Information displayed on homepage 12 can be programmed to update automatically and continuously, for example, the time of day, date, and weather. Other information can be stored as saved content directly on a memory drive incorporated into device 10. Stored information can include telephone numbers and pictures. The content can be stored locally on the device 10 or remotely through a website provider. Storing certain content locally can allow for accessibility of certain information if the internet connection is lost temporarily or for an extended period of time. In an example, certain content is downloaded and saved locally on device 10 periodically to avoid issues associated with lost internet connection. Device 10 can be preprogrammed to send a request to a remote server at periodic time intervals to obtain updated content. Moreover, a homepage service provider can program a system to send updated content at a predetermined time interval or whenever an update occurs such as a change to the to-do list or the like.

The present disclosure further provides for allowing the user to update particular content such as completion of certain tasks. For example, a task instructs the user to take certain medication. The user can complete the task, i.e., take the medication, and touch a button on the display that reads “done” or “complete” or pills taken. A further indicia, i.e., a sound, change of color, or check mark, can display in connection with that particular tab. Moreover, the homepage will send a communication to the server to allow for the authorized individuals to see that the task is complete. Accordingly, when a caregiver or authorized individual views the web-based application to monitor the homepage, they will see that the task is complete.

The present disclosure provides for a system for remotely delivering content to a user of device 10 through a homepage 12. The system can be accessed and modified by an authorized individual. The authorized individual is able to remotely access a server hosting the homepage 12 and modify its content through a modifying website display 40 (e.g., FIG. 4). Remote access can achieved through an internet connection and can be made from any personal computer or device such as a tablet or smart phone. In an example, a user of device 10 may have one or more adult children who are authorized to periodically update the homepage 12 including making changes to the information in the icons such as the to-do list icon 15, schedule of events icon 14, and photo album icon 16c as well as message display 14. In an example, the authorized individual may remotely access the homepage 12 and enter a message that reads “ . . . Don't worry about your insurance—you paid the bill on March 19th! . . . . ” Once saved and through the remote access, the message is then displayed in message display 17. The remote accessibility to the dedicated homepage by the family members of the patient allows for increased communication efficiency and effectiveness, particularly when the patient is obsessively concerned and worried about a particular issue and needs frequent reminders to alleviate the stress.

In an example embodiment, several caregivers can access a homepage of a single user or patient. For example, an adult daughter in a distant city, an adult son in his office, and a home health agency care coordinator can all be given access to a particular user's account via a distinct password. Each caregiver can be given a different level of security access. For example, a care coordinator and the primary family caregiver may have access to both view and edit content, while grandchildren and home health workers may be able to view the content on the device, but not to edit it or allowed edit functionality to non-medical content such as the photo album. This helps to coordinate care among all responsible parties so that each caregiver is aware of important information posted by others.

In this example, the homepage 12 can be accessed through a dedicated website accessible by authorized individuals to update information and provide content. The website allows for authorized individuals to logon through a dedicated section of the website and access their dedicated homepage. The dedicated area can be established to be password protected. Accordingly, a patient's son or daughter can login to the dedicated website to send a message that crawls along the screen of the patient's homepage on their particular device, update pictures, submit a reminder, or the like. Device 10 can be configured and customized by the authorized individual(s) to meet particular, changing needs of the patient.

The device can further include an alarm or notification system when updates occur. In a further example, the device 10 can include a microphone and a message system wherein the patient can record a message or question, upload it to the homepage 12, and have that message be accessible by the authorized individuals remotely. Then the authorized individuals can be notified that a message for them is waiting and can respond accordingly. For example, the patient can record a message that states, “I can't remember if I take 2 blue pills or 3?” The notification system notifies at least one authorized individual, such as the patient's adult children or a dedicated caretaker, to allow them to either call the patient or send a scrolling message with a response to the original message. A corresponding audio alert can be provided that corresponds to transmission of a new or updated message. The system can then communicate a collective acknowledgement to each authorized user when a response has been communicated to the patient. This can prevent multiple caretakers or family members from confusing or over communicating with the patient.

In a further embodiment, the website includes a communication and modification tracking application. This allows each authorized caretaker or family member to monitor activity associated with the homepage of the patient. The tracking system can show the date of the modification, the content of the modification, and the individual or individuals who were involved. For example, if a son of the patient accesses the website after being away on vacation or a work related trip, he can see what transpired over the period of his absence between his parent (i.e., the patient) and the caregiver or other authorized family members. The website further allows discussion and messaging between and among the authorized individuals and caretakers.

In a further embodiment, a “Help” button on the device can be touched by the user to alert caregivers that help is needed. Distribution and response strategies associated with a help notification can be predetermined by the caregivers and patients particular needs. For example, in one family, a home health agency would be notified during daytime hours, while a family member receives the notification after hours. In another family, adult children may take turns being “on call” during different days of the week. The help button can be set to send a text message, email, or both to one or more caregivers.

In an example, a family can purchase a touch-screen device 10 according to the present disclosure that connects to the internet. It can include audio capability to sound alarms, including favorite ringtones, provide audio content and video, etc. It can be operable to display many web pages, accessible by touching words or icons. It can be modified and updated remotely by family members or authorized individuals who have access to a web-based service.

In an example, the dedicated device 10 hosts a dedicated software application corresponding to homepage 12. The software can be programmed to be wholly or partially blocked (e.g., hardware and/or software with protection such as password protection) from allowing direct modification by the user of the device. The device can further be made to limit content through the web-based interface and prevents any inadvertent navigation to undesired website locations. This can prevent a patient from accidentally adding, deleting, or modifying certain information or navigating to a different website thereby causing confusion to the user. In particular circumstances, allowing the patient to adjust the display or content of their dedicated homepage would create increased confusion and further anxiety. The device 10 can be configured to allow for reprogramming or clearing the dedicated software to standard computing use if the user no longer intends to use it. In an example, three separate buttons must be pressed or actuated in a predetermined sequence to allow the device to be cleared and thus functional for other purposes such as a standard portable computing device.

The web-based service can provide a dedicated website for each subscribing or participating individual. The service can provide access to any number of authorized individuals. In a particular embodiment, a primary authorized individual can be designated to give final decision making over who can and cannot have access to the website and whether or not those individuals can update and/or modify content. The website can have password-protected logins for several members. They can enter the site and immediately see what is visible on the patient's touch screen device, and access other pages of the patient's site.

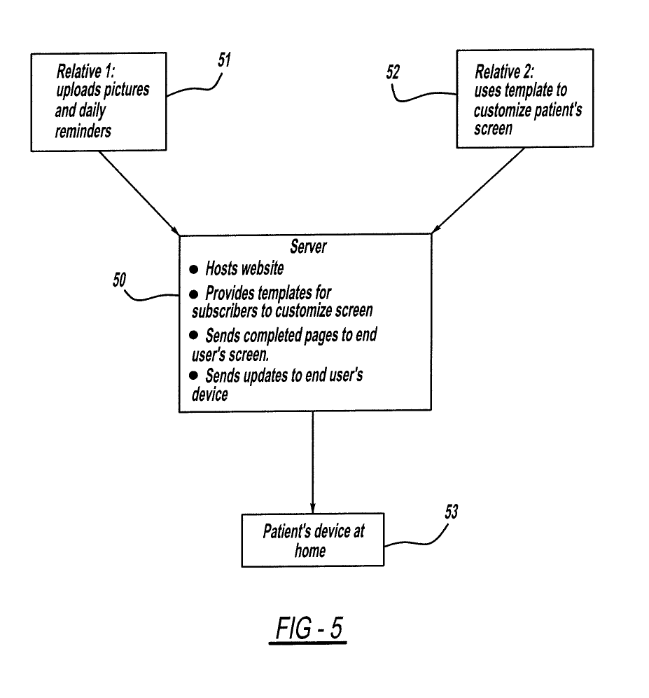

FIG. 5 illustrates an example flow chart and methodology of a system of the present disclosure. In this example, a first relative of the patient is represented in box 51 and can upload pictures and daily reminders to a server 50. Another relative or authorized user in box 52 can use a template provided by the web-based service to customize the patient's homepage screen. The server 50 can be located remotely and operated or rented by the web-based service provided. The server 50 can perform several functions including but not limited to, hosting the website, providing templates for subscribers/users to customize the homepage screen, transmit or send completed pages to a user's homepage, send updates to the user's device, and the like.

Table 1 below illustrates various example icons and gadgets that can further be included on the individual's homepage according to a user's preference. Additional icons or applications can be customized and preselected through the web application by an authorized individual. Each icon can be a link to information, a website, uploaded information or content, or the like.

TABLE 1
Examples of Optional Gadgets

Prayer of the Day
Joke of the Day
News
Extra text boxes and photo spots
Crawler lines for obsessive worries
Word of the Day
Stock Quotes
Comics
Photo albums for collections
Unlimited links for external sites

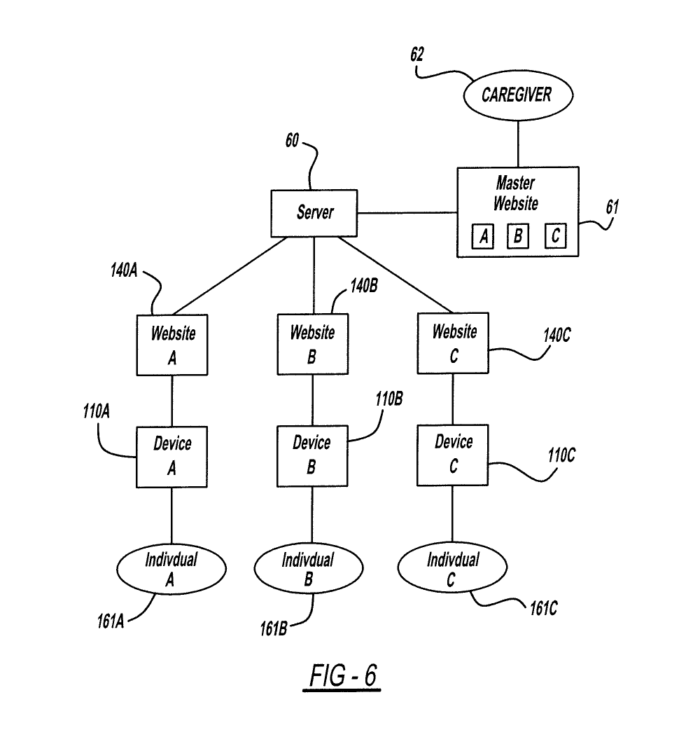

The present disclosure further provides for a system allowing for a caregiver to access a master website hosted on the server which is configured to provide caregivers with access to a plurality of dedicated patient accounts (i.e., individual dedicated websites) from a single console remotely. Referring to the flow chart of FIG. 6, a master website 61 is provided that is hosted on the server 60. The diagram of FIG. 6 illustrates a multi-patient care management system according to the present disclosure. In an example, a care coordinator or caregiver 62 can be associated with a home health care agency or an assisted living facility and may have more than one patient or individual with cognitive impairment. In this example, three individuals A, B, C represented by boxes 161A, 161B, and 161C are each diagnosed with varying degrees of cognitive impairment. Each individual 161A-161C utilizes a dedicated device 10 represented by boxes 110A, 1108, and 110C. Each device displays a unique individualized homepage 12 corresponding to a unique website 140A, 140B, and 140C. The caregiver 62 can gain access to all current accounts (i.e., the homepage 12 corresponding to each website 140A-140C) through the master website 61 with a single password and login, and can switch views from one account to another. In addition, a caregiver 62 can access a specific kind of information by attributes from all or some of the accessible accounts. For example, to see which patient needs medication administered at a given time, or which persons need a ride to the voting booth on Tuesday, the caregiver 62 can click on a particular function of the master website to display desired information or searching by specific attributes.

Loss of short-term memory is a difficult and often life-changing problem that is expected to afflict many more people as the boomer generation ages and life spans increase. The current generation is more likely to live further away from supportive family members and is less likely than previous generations to have members who do not work outside the home and have time available to care for the elderly. During the early and even middle stages of Alzheimer's disease, a device that aids with memory can make a significant difference in the life of dementia patients, possibly enabling them to stay in their own homes longer, while also providing relief for family members.

Many modifications and variations of the present disclosure are possible in light of the above teachings. Therefore, within the scope of the appended claim, the present disclosure may be practiced other than as specifically described.

What is claimed is:

1. A system for assisting an individual with cognitive impairment comprising:
(a) a display device adapted to connect to a remote server;
(b) a dedicated website hosted on the remote server and remotely accessible by an authorized individual, the website hosting dedicated content for the individual with cognitive impairment;
(c) a homepage displayed on the display device, wherein the homepage displays content provided by the dedicated website; and
(d) a plurality of information icons provided on the homepage, the information icons adapted to display the dedicated content from the dedicated website;
wherein the authorized individual selects, modifies, and transmit the dedicated content to the homepage through the website.

2. The system of claim 1 wherein the homepage is customizable according to preferences of the individual with cognitive impairment.

3. The system of claim 1 wherein each information icon defines an illustrative or text indicia associated with specific content to be viewed on the display device.

4. The system of claim 1 further comprising a plurality of authorized individuals each given a unique password and a predetermined authorized security level for content modification for the homepage.

5. The system of claim 5 wherein each authorized individual is notified when a modification to the homepage has occurred or a communication between the website and the homepage has been transmitted.

6. The system of claim 1 wherein the information icons display: (a) current day of the week, date, and time data; (b) a schedule of events; (c) a to-do list; and (d) a scrolling dedicated message provided by an authorized individual.

7. The system of claim 6 wherein the authorized individual selects which information icons to display on the homepage.

8. The system of claim 1 wherein the display device includes auditory notification adapted to deliver audible messages or alarms associated with the information icons.

9. The system of claim 1 wherein the display device is configured to prevent homepage modification capability by the individual with cognitive impairment.

10. The system of claim 1 wherein the display device includes an audio recording feature to allow voice recordings to the homepage and uploaded back to the website for access by the authorized individual.

11. The system of claim 1 wherein at least one of the information icons is a task list which includes and actionable completion button to be activated by the individual with cognitive impairment, wherein activating the completion button communicates to the website that the task is completed.

12. The system of claim 1 wherein the authorized individual can directly communicate with the individual with cognitive impairment through audio content or electronic messaging through the website and the homepage.

13. The system of claim 1 wherein the website includes a tracking application adapted to record and monitor modifications to the homepage and communications between the website and the homepage.

14. The system of claim 1 wherein the display device is configured to return to a homepage view after a predetermined length of time has passed.

15. The system of claim 1 wherein the authorized individual can remotely actuate an audio alert included in the display device.

16. A method of assisting an individual suffering from cognitive impairment comprising the steps of:
(a) connecting a display device to a remote server hosting a dedicated website having content dedicated for the individual with cognitive impairment;
(b) displaying a homepage on the display device, wherein the homepage displays content provided by the dedicated website;
(c) accessing the dedicated website remotely to modify, transmit, or upload content to the dedicated website, wherein access to the dedicated website and modification ability is limited to one or more authorized individuals; and
(d) transferring the content from the dedicated website to the homepage for viewing by the individual with cognitive impairment on the display device.

17. The method of claim 16 wherein the modification of the website includes the steps of: (a) accessing the dedicated website by an authorized individual; (b) selecting one or more content options to be viewed on the homepage; (c) optionally providing a personalized message; and (d) transmitting the modifications to be viewed on the homepage.

18. A system for management of care for a plurality of individuals with cognitive impairment comprising:
(a) a plurality of display devices adapted to connect to a remote server, each device associated with a unique homepage configured for each unique individual with cognitive impairment;
(b) a plurality of dedicated websites hosted on the remote server and remotely accessible by an authorized caregiver, wherein each dedicated website is adapted to provide unique content to a corresponding homepage hosted on the display devices for the associated individual with cognitive impairment; and
(c) a dedicated master website hosted on the server configured to allow access by the authorized caregiver to view, modify, and provide content to each dedicated website to be viewed in the unique homepage for each individual with cognitive impairment.

19. The system of claim 18 wherein the master website is accessible remotely by the authorized caregiver.

20. The system of claim 18 wherein the caregiver can view content-based views by sorting information by one or more desired attributes.
